(19) United States
(12) Patent Application Publication
(10) Pub. No.: US 2019/0352125 A1
(43) Pub. Date: Nov. 21, 2019

(54) AUTONOMOUS HEALTH CHECK EMBEDDED SOFTWARE USING AN AUTONOMOUS ROBOT

(71) Applicant: OTIS ELEVATOR COMPANY, Farnington, CT (US)

(72) Inventors: Shane Wooten, Ocala, FL (US); Daniel P. Archibald, Harrison, NY (US); Michael P. Keenan, JR., Suffield, CT (US)

(21) Appl. No.: 15/981,256

(22) Filed: May 16, 2018

(51) Int. Cl. B66B 5/00; G05D 1/00; G01P 15/14; G05B 19/401

(52) U.S. Cl. CPC B66B 5/0087; B66B 5/0025; G05D 1/0088; G05B 2219/45066; G05B 19/401; G05D 2201/0207; G01P 15/14

(57) ABSTRACT

A robot for performing diagnostics on a conveyance system is provided. The robot including: a controller configured to control operation of the robot; a propulsion system configured to move the robot to a conveyance system; and a data collection system configured to collect data of the conveyance system, the data collection system comprising at least one of: an inertial measurement unit (IMU) sensor configured to detect an acceleration of a conveyance apparatus of the conveyance system; a camera configured to capture images of the conveyance system; and a microphone configured to detect sound emanating from the conveyance system.

### BACKGROUND

The subject matter disclosed herein relates generally to the field of conveyance systems, and specifically to a method and apparatus for diagnosing conveyance systems.

Conveyance systems such as, for example, elevator systems, escalator systems, and moving walkways may require periodic diagnostics requiring a technician to be called and perform a manual inspection of the system in the field. The availability of technicians and travel time for the technician to the field site all factor into the time it may take to reach a system diagnosis.

### BRIEF SUMMARY

According to an embodiment, a robot for performing diagnostics on a conveyance system is provided. The robot including: a controller configured to control operation of the robot; a propulsion system configured to move the robot to a conveyance system; and a data collection system configured to collect data of the conveyance system, the data collection system including at least one of: an inertial measurement unit (IMU) sensor configured to detect an acceleration of a conveyance apparatus of the conveyance system; a camera configured to capture images of the conveyance system; and a microphone configured to detect sound emanating from the conveyance system.

In addition to one or more of the features described herein, or as an alternative, further embodiments may include that the conveyance system is an elevator system and the conveyance apparatus is an elevator car.

In addition to one or more of the features described herein, or as an alternative, further embodiments may include that the controller is configured to diagnose the data collected by the data collection system in response to at least one of the acceleration of the conveyance apparatus detected by the IMU sensor, the images of the conveyance system captured by the camera, and the sound emanating from the conveyance system detected by the microphone.

In addition to one or more of the features described herein, or as an alternative, further embodiments may include: a communication module in communication with the controller, the controller is configured to wirelessly communicate with at least one of a computing network and a controller of the conveyance system through the communication module.

In addition to one or more of the features described herein, or as an alternative, further embodiments may include that the controller of the robot is configured to wirelessly communicate with the controller of the conveyance system through the communication module and download performance data of the conveyance system from the controller of the conveyance system.

In addition to one or more of the features described herein, or as an alternative, further embodiments may include that the controller is in communication with a remote device through the computing network and the controller is configured to transmit data collected by the data collection system to the remote device, and the remote device is configured to diagnose the data collected by the data collection system in response to at least one of the acceleration of the conveyance apparatus detected by the IMU sensor, the images of the conveyance system captured by the camera, and the sound emanating from the conveyance system detected by the microphone.

In addition to one or more of the features described herein, or as an alternative, further embodiments may include: a probe configured to physically connect to a probe receiver on the conveyance apparatus, the probe receiver being in communication with a controller of the conveyance system.

In addition to one or more of the features described herein, or as an alternative, further embodiments may include a propulsion system configured to move the robot onto a conveyance apparatus of the conveyance system; and a data collection system configured to collect data of the conveyance system when the robot is on the conveyance apparatus.

In addition to one or more of the features described herein, or as an alternative, further embodiments may include that the controller of the robot is configured to autonomously control the operation of the robot.

In addition to one or more of the features described herein, or as an alternative, further embodiments may include that the propulsion system is configured to move the robot to the conveyance system in accordance with an inspection schedule or in response to a request from a controller of the conveyance system.

In addition to one or more of the features described herein, or as an alternative, further embodiments may include that the controller is in communication with a remote device through the computing network, the remote device being configured to control operation of the robot through the computing network.

According to another embodiment, a method of performing diagnostics on a conveyance system is provided. The method including: controlling operation of a robot using a controller of the robot; moving a robot to a conveyance system using a propulsion system of the robot; and collecting data of the conveyance system using a data collection system of the robot. Collecting data includes at least one of: detecting an acceleration of a conveyance apparatus of the conveyance system using an inertial measurement unit (IMU) sensor; capturing images of the conveyance system using a camera; and detecting sound emanating from the conveyance system using a microphone.

In addition to one or more of the features described herein, or as an alternative, further embodiments may include that the conveyance system is an elevator system and the conveyance apparatus is an elevator car.

In addition to one or more of the features described herein, or as an alternative, further embodiments may include: diagnosing, using the controller, the data collected by the data collection system in response to at least one of the acceleration of the conveyance apparatus detected by the IMU sensor, the images of the conveyance system captured by the camera, and the sound emanating from the conveyance system detected by the microphone.

In addition to one or more of the features described herein, or as an alternative, further embodiments may include: transmitting, using a communication module of the robot, the data collected by the data collection system to a remote device, the communication module is in communication with the remote device through a computing network, the remote device is configured to diagnose the data collected by the data collection system in response to at least one of the acceleration of the conveyance apparatus detected by the IMU sensor, the images of the conveyance system captured by the camera, and the sound emanating from the conveyance system detected by the microphone.

In addition to one or more of the features described herein, or as an alternative, further embodiments may include: connecting a probe of the robot to a probe receiver on the conveyance apparatus, the probe receiver being in communication with a controller of the conveyance system; and downloading performance data from the controller of the conveyance system to the controller of the robot through the probe.

In addition to one or more of the features described herein, or as an alternative, further embodiments may include that a propulsion system configured to move the robot onto a conveyance apparatus of the conveyance system; and a data collection system configured to collect data of the conveyance system when the robot is on the conveyance apparatus.

In addition to one or more of the features described herein, or as an alternative, further embodiments may include that the controller of the robot is configured to autonomously control the operation of the robot.

In addition to one or more of the features described herein, or as an alternative, further embodiments may include that the propulsion system is configured to move the robot to the conveyance system in accordance with an inspection schedule or in response to a request from a controller of the conveyance system.

Technical effects of embodiments of the present disclosure include using a semi-autonomous or fully autonomous robot to perform diagnostics on conveyance systems.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a schematic view of a robot used to perform diagnostics on the elevator system of FIG. 1, in accordance with an embodiment of the disclosure; and

FIG. 3 is a flow chart of method of performing diagnostics on an elevator system, in accordance with an embodiment of the disclosure.

### DETAILED DESCRIPTION

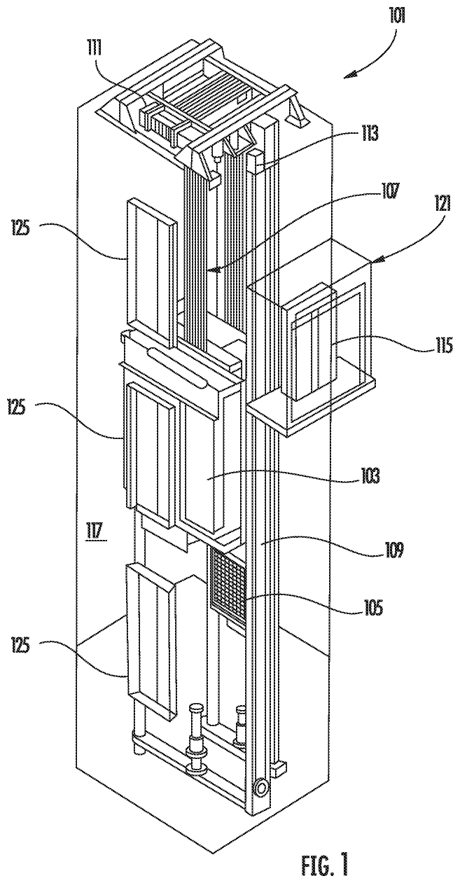

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

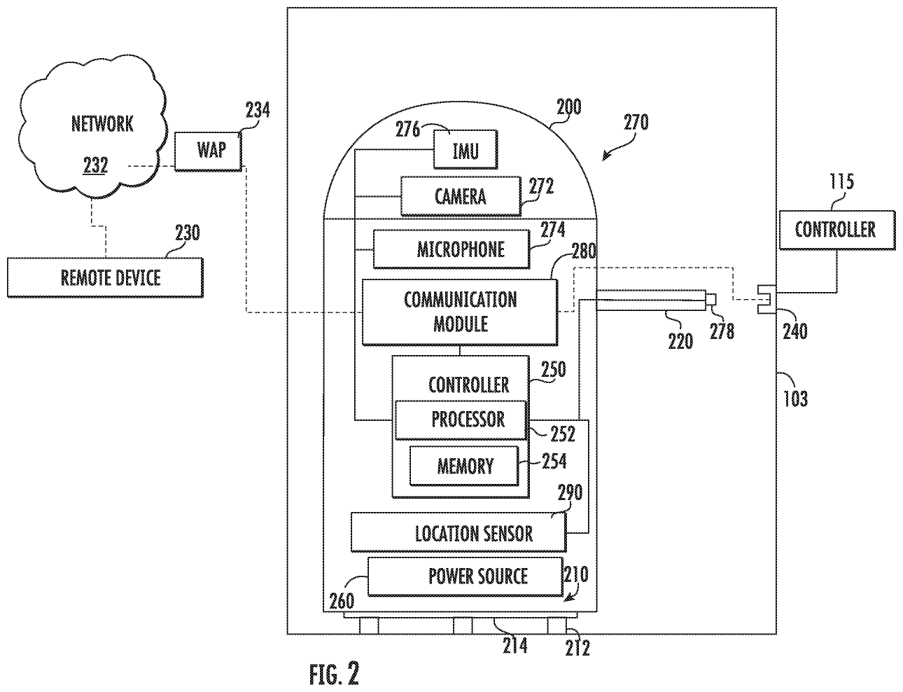

Referring now to FIG. 2 with continued reference to FIG. 1. FIG. 2 illustrates a robot 200 configured to collect data to perform diagnostics on the elevator system 101 of FIG. 1. It is understood that while an elevator system 101 is utilized for exemplary illustration, embodiments disclosed herein may be applied to other conveyance systems utilizing conveyance apparatuses for transportation such as, for example, escalators, moving walkways, etc. The embodiment illustrated in FIG. 2 shows an elevator car 103 as the conveyance apparatus and the elevator system 101 as the conveyance system. The robot 200 is configured to board an elevator car 103 autonomously and/or semi-autonomously and ride the elevator car 103 in order to collect data and perform diagnostics on the elevator system 101 and/or connect to the controller 115 of the elevator system 101 to perform diagnostics. The robot 200 includes a propulsion system 210 to move the robot 200 and onto an elevator car 103. In an example, the robot 200 may be moved from a docking station through hallways of a building and into the elevator car 103 using the propulsion system of the robot 200. The propulsion system 210 may be a wheel system 212, powered by an onboard motor 214. In an example, the robot 200 may be driven on the wheel system 212 onto the elevator car 103, as shown in FIG. 2. It is understood that while the wheel system 212 is utilized for exemplary illustration, embodiments disclosed herein may be applied to robots having other propulsions systems for transportation such as, for example, a rotorcraft system, a hovercraft system, a tread system, etc. The robot 200 includes a power source 260 configured to power the robot 200. In an embodiment, the power source 260 may be an onboard battery system.

The robot 200 may be stored on site at a building containing multiple elevator systems 101 and may be utilized to diagnose the multiple elevator systems 101 by boarding each elevator car 103 of the multiple elevator systems 101. Advantageously, by utilizing the robot 200 to diagnose multiple elevator systems 101, it avoids having to add a complex and expensive sensor system to each elevator car 103 to perform diagnostics, rather the sensor system (i.e. the robot 200) is brought to each elevator car 103.

In an embodiment, the robot 200 may collect data on the elevator system 101 and perform diagnostics on the data collected. In another embodiment, the robot 200 may collect data on the elevator system 101 and then transmit the data to a remote device 230 where the diagnostics is to be performed.

The remote device 230 may be connected to a computer network 232 to retrieve the data or diagnostics collected by the robot 200. The computer network 232 may be a cloud computing network. If the remote device 230 receives raw data from the robot 200, diagnostics/data analysis may be performed on the remote device 230. In an example, the remote device 230 may be a computing device such as a desktop computer. The remote device 230 may also be a mobile computing device that is typically carried by a person, such as, for example a phone, PDA, smart watch, tablet, laptop, etc. The remote device 230 may also be two separate devices that are synced together such as, for example, a cellular phone and a desktop computer synced over an internet connection. The remote device 230 may also allow an elevator technician to remotely control the robot 200 through the remote device 230, which advantageously may allow the elevator technician to remotely perform inspections of elevator systems 103 to collect data. The cloud network 232 or the controller 250 may control the operation of the robot 200 to collect data, process the data, and then transmit the data to the cloud and/or the remote device 230.

The robot 200 may be controlled by the elevator technician remotely, semiautonomous, or fully autonomous. In an embodiment, the robot 200 is completely controlled by the elevator technician and may collect data while being controlled remotely by an elevator technician using the remote device 230. In another embodiment, the robot 200 is fully autonomous and may collect data fully autonomously according to an inspection schedule. In another embodiment, the robot 200 is fully autonomous and may collect data fully autonomously in response to a request from a controller 115 of the elevator system 101. In yet another embodiment, the robot 200 may be semi-autonomous and a remote elevator technician may instruct the robot 200 to collect data on specific elevator system 101 and then the robot 200 will autonomously go to the specific elevator system 101 to collect the data.

The robot 200 may collect data on the elevator system 101 using a data collection system 270 including at least one of an inertial measurement unit (IMU) sensor 276, a camera 272, a microphone 274, and data probe 278. The IMU sensor 276 is configured to detect accelerations of the robot 200 and of the elevator car 103 when the robot 200 is within the elevator car 103. The IMU sensor 276 may be a sensor such as, for example, an accelerometer, a gyroscope, or a similar sensor known to one of skill in the art. The IMU sensor 276 may detect accelerations as well as derivatives or integrals of accelerations, such as, for example, velocity, jerk, jounce, snap . . . etc. Advantageously, by utilizing the robot 200 to detect accelerations of the elevator 103 when the robot 200 is physically in the elevator car 200, the robot 200 will experience similar accelerations felt by a human passengers and thus appropriate diagnostics may be performed to ensure that passenger comfort is maintained. Also advantageously, by detecting accelerations through the IMU sensor 276, unusual vibrations of the elevator car may be detected remotely and maintenance activities may be scheduled in response to the unusual vibrations.

The camera 272 may be configured to capture images of the elevator system 101 or of the elevator car 103. The camera 272 may be a still image camera, a video camera, and/or thermal camera. The camera 272 may also capture panoramic images or virtual reality (VR) images. The VR images may allow an offsite elevator technician to put on a VR headset and view the VR images as if the technician was actually in the elevator car 103, allowing the elevator technician to examine the interior of the elevator car 103 through VR. Advantageously, by capturing images through the camera 272 the elevator system 101 may be inspected remotely and cleanings and/or other maintenance activities may be scheduled in response to the images. For example, the camera 272 may capture images of various aspects of the elevator system 101 including but not limited to the interior of the elevator car 103, a machine room, a controller room, etc.

The microphone 274 is configured to detect sound. When the robot 200 is located within the elevator car 103, the microphone 274 is configured to detect audible sound emanating from the elevator system 101. Advantageously, by detecting sound through the microphone 274 unusual noises experienced inside the elevator car 103 may be detected remotely and maintenance activities may be scheduled in response to the noises.

The robot 200 may also connect to the controller 115 of the elevator system 101 in order to perform diagnostics on the elevator system 101. Some existing elevator systems 101 are not connected to the internet of things (IoT) and thus in order to download performance data a technician must be sent onsite to the elevator system 101 and connect to the elevator car 103 to download performance data. Advantageously, the robot 200 may be utilized to connect to the controller 115 of the elevator system 101 to download performance data of the elevator system 101 and then transmit the performance data to a remote device 250 for further analysis. Alternatively, the controller 250 of the robot 200 may analyze the performance data or the performance data may be analyzed by a cloud network 232 and/or remote device 230. The robot 200 may connect to the controller 115 wirelessly through the communication module 280 using short range radio communication, such as for example, near field communication (NFC), Bluetooth, infrared, ZigBee, or Wi-Fi. Once a wireless connection is established between the controller 115 and the communication module 280, the controller 250 of the robot 200 may download performance data of the elevator system 101 from the controller 115 of the elevator system 101. Alternatively, the robot 200 may establish a hardwire connection through a probe 278 that physically plugs into a probe receiver 240 in communication with the controller 115. The probe receiver 240 may be located in the elevator car 103 as seen in FIG. 2 or proximate the elevator system 101 (e.g., in a hallway, or controller room 121). The probe 278 may be located on a probe arm 220 attached to the robot 200. The probe arm 220 may be an articulating and configured to insert the probe 278 into the probe receiver 240. Once inserted into the probe receiver 240, the controller 250 of the robot 200 may download performance data of the elevator system 101 from the controller 115 of the elevator system 101.

The electronic controller 250 of the robot 200 includes a processor 252 and an associated memory 254 including computer-executable instructions that, when executed by the processor 252, cause the processor 252 to perform various operations. The processor 252 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 254 may be a storage device such as, for example, a random access memory (RAM), read only memory (ROM), or other electronic, optical, magnetic or any other computer readable medium.

The robot 200 includes a communication module 280 configured to allow the controller 250 of the robot 200 to communicate with at least one of the controller 115 of the elevator system 101, a wireless access protocol device 272, and a computer network 232. The a communication module 280 is capable of transmitting and receiving data to and from at least one of the controller 115 of the elevator system 101, a wireless access protocol device 272, and a computer network 232. The communication module 280 may, for instance, be a near field communication (NFC), Bluetooth, infrared, ZigBee, Wi-Fi, cellular, satellite, transceiver, or another appropriate wireless transceiver. The communication module 280 may be configured to communicate collected data/diagnostics from the robot 200 to a remote device 230 through a computer network 232. The communication module 280 may be in direct wireless communication with the computer network 232 or may communicate to the computer network 232 through a wireless access protocol device (WAP) 234. For instance the wireless access protocol device 234 may be located within a building containing the elevator system 101 and communication module 280 may be in wireless communication with the WAP 234.

In one embodiment, the robot 200 also includes location sensor system 290 configured to detect the location of the robot 200. The location of the robot 200 may also include the location of the robot 200 relative to other objects in order allow the robot to navigate through hallways of a building to elevator cars 103 and prevent the robot 200 from bumping into objects. The location sensor system 290 may utilize GPS in order to detect a location of the robot 200. The location sensor system 290 may also utilize triangulation of wireless signals within the building in order to determine a location of the robot 200 within a building. For example, the location sensor system 290 may triangulate the position of the robot 200 with a building utilizing signal strength of wireless signals from WAPs 234 in known locations throughout the building. In order to avoid colliding with objects, the location sensor system 290 may use SONAR, LIDAR, image recognition, or any other similar sensing system known to one of skill in the art.

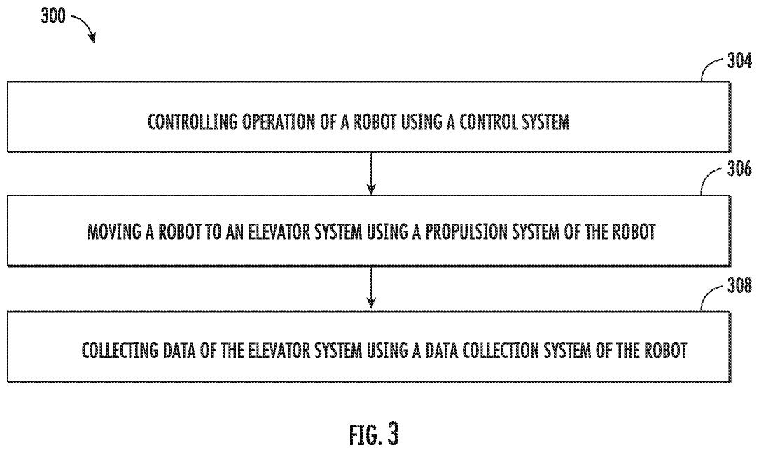

Referring now to FIG. 3, while referencing components of FIGS. 1 and 2. FIG. 3 shows a flow chart of method 300 performing diagnostics on an elevator system 101, in accordance with an embodiment of the disclosure. At block 304, operation of a robot 200 is controlled using a controller 250 of the robot 200. The controller 250 may autonomously control the robot 200 or the robot 200 may be controlled through a remote device 230 connected over a network 232, as discussed above. The propulsion system 214 is configured to move the robot 200 to the elevator system in accordance with an inspection schedule or in response to a request from the controller 115 of the elevator system 101. For example, the controller 115 may detect performance data that is abnormal and would like the robot 200 to perform an inspection. At block 306, the robot 200 is moved to an elevator system 101 using a propulsion system 210 of the robot 200. The robot 200 may be moved proximate to an elevator system 101 and/or on to the elevator car 103 of the elevator system 101. The robot 200 may be moved proximate to an elevator system 101 to connect wirelessly to the elevator system 101 and/or connect to a data port outside of the elevator car 103. At block 308, data of the elevator system 101 is collected using a data collection system 270 of the robot 200. As mentioned above, data of the elevator system 101 may be collected by at least one of: detecting an acceleration of the elevator car 103 using an IMU sensor 276; capturing images of the elevator system 103 using a camera 272; and detecting sound emanating from the elevator system 103.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A robot for performing diagnostics on a conveyance system, the robot comprising:
a controller configured to control operation of the robot;
a propulsion system configured to move the robot to a conveyance system; and
a data collection system configured to collect data of the conveyance system, the data collection system comprising at least one of:
an inertial measurement unit (IMU) sensor configured to detect an acceleration of a conveyance apparatus of the conveyance system;
a camera configured to capture images of the conveyance system; and
a microphone configured to detect sound emanating from the conveyance system.

2. The robot of claim 1, wherein the conveyance system is an elevator system and the conveyance apparatus is an elevator car.

3. The robot of claim 1, wherein the controller is configured to diagnose the data collected by the data collection system in response to at least one of the acceleration of the conveyance apparatus detected by the IMU sensor, the images of the conveyance system captured by the camera, and the sound emanating from the conveyance system detected by the microphone.

4. The robot of claim 1, further comprising:
a communication module in communication with the controller, wherein the controller is configured to wirelessly communicate with at least one of a computing network and a controller of the conveyance system through the communication module.

5. The robot of claim 4, wherein the controller of the robot is configured to wirelessly communicate with the controller of the conveyance system through the communication module and download performance data of the conveyance system from the controller of the conveyance system.

6. The robot of claim 4, wherein the controller is in communication with a remote device through the computing network and the controller is configured to transmit data collected by the data collection system to the remote device, and wherein the remote device is configured to diagnose the data collected by the data collection system in response to at least one of the acceleration of the conveyance apparatus detected by the IMU sensor, the images of the conveyance system captured by the camera, and the sound emanating from the conveyance system detected by the microphone.

7. The robot of claim 1, further comprising:
a probe configured to physically connect to a probe receiver on the conveyance apparatus, the probe receiver being in communication with a controller of the conveyance system.

8. The robot of claim 1, further comprising:
a propulsion system configured to move the robot onto a conveyance apparatus of the conveyance system; and
a data collection system configured to collect data of the conveyance system when the robot is on the conveyance apparatus.

9. The robot of claim 1, wherein
the controller of the robot is configured to autonomously control the operation of the robot.

10. The robot of claim 1, wherein the propulsion system is configured to move the robot to the conveyance system in accordance with an inspection schedule or in response to a request from a controller of the conveyance system.

11. The robot of claim 4, wherein the controller is in communication with a remote device through the computing network, the remote device being configured to control operation of the robot through the computing network.

12. A method of performing diagnostics on a conveyance system, the method comprising:
controlling operation of a robot using a controller of the robot;
moving a robot to a conveyance system using a propulsion system of the robot; and
collecting data of the conveyance system using a data collection system of the robot, wherein collecting data comprises at least one of:
detecting an acceleration of a conveyance apparatus of the conveyance system using an inertial measurement unit (IMU) sensor;
capturing images of the conveyance system using a camera; and
detecting sound emanating from the conveyance system using a microphone.

13. The method of claim 12, wherein the conveyance system is an elevator system and the conveyance apparatus is an elevator car.

14. The method of claim 12, further comprising:
diagnosing, using the controller, the data collected by the data collection system in response to at least one of the acceleration of the conveyance apparatus detected by the IMU sensor, the images of the conveyance system captured by the camera, and the sound emanating from the conveyance system detected by the microphone.

15. The method of claim 12, further comprising:
transmitting, using a communication module of the robot, the data collected by the data collection system to a remote device, wherein the communication module is in communication with the remote device through a computing network, wherein the remote device is configured to diagnose the data collected by the data collection system in response to at least one of the acceleration of the conveyance apparatus detected by the IMU sensor, the images of the conveyance system captured by the camera, and the sound emanating from the conveyance system detected by the microphone.

16. The method of claim 12, further comprising:
connecting a probe of the robot to a probe receiver on the conveyance apparatus, the probe receiver being in communication with a controller of the conveyance system; and
downloading performance data from the controller of the conveyance system to the controller of the robot through the probe.

17. The method of claim 12, wherein
a propulsion system configured to move the robot onto a conveyance apparatus of the conveyance system; and
a data collection system configured to collect data of the conveyance system when the robot is on the conveyance apparatus.

18. The method of claim 12, wherein
the controller of the robot is configured to autonomously control the operation of the robot.

19. The method of claim 12, wherein the propulsion system is configured to move the robot to the conveyance system in accordance with an inspection schedule or in response to a request from a controller of the conveyance system.
